(19) United States
(12) Patent Application Publication
(10) Pub. No.: US 2011/0077328 A1
(43) Pub. Date: Mar. 31, 2011

(54) USE OF FILLER THAT UNDERGOES ENDOTHERMIC PHASE TRANSITION TO LOWER THE REACTION EXOTHERM OF EPOXY BASED COMPOSITIONS

(76) Inventors: Ludovic Valette, Shanghai (CN); Ernesto Occhiello, Houston, TX (US); Thomas Debruyne, Draveil (FR)

(21) Appl. No.: 12/936,001

(22) PCT Filed: Apr. 7, 2009
(86) PCT No.: PCT/US09/39722

§ 371 Date: Nov. 17, 2010

Related U.S. Application Data
(60) Provisional application No. 61/044,820, filed on Apr. 14, 2008.

(51) Int. Cl. C08L 63/00; B82Y 30/00

(52) U.S. Cl. 523/400; 977/773; 977/902

(57) ABSTRACT

Disclosed are curable epoxy-based resins having a lower peak exotherm during cure, as well as thermoset resins and epoxy-based parts formed from the curable epoxy-based compositions. The epoxy-based compositions having a lower peak exotherm during cure may include: at least one epoxy resin, at least one hardener, and at least one endothermic transition additive. The thermoset resin may include the reaction product of the curable epoxy-based resins having a lower peak exotherm during cure, which may be useful when forming large epoxy-based parts, such as those including 200 grams or more of the thermoset resin. Also disclosed is a process for forming curable epoxy-based resins having a lower peak exotherm during cure, including: admixing at least one epoxy resin; at least one hardener; and at least one endothermic transition additive; to form a curable composition. The resulting curable composition may then be thermally cured at a temperature of at least 60° C. to form a thermoset resin.

### BACKGROUND OF DISCLOSURE

1. Field of the Disclosure

Embodiments disclosed herein relate generally to epoxy-based compositions having a low reaction exotherm. More specifically, embodiments disclosed herein relate to epoxy-based compositions including an epoxy resin, a hardener, and an endothermic transition additive, wherein the epoxy-based composition has a lower reaction exotherm due to the presence of the endothermic phase transition additive.

2. Background

The reaction between an epoxy resin and a hardener (also called curing agent, such as amines and anhydrides) is exothermic, liberating a large amount of heat. When producing large parts with epoxy based compositions, the exotherm of reaction is a significant safety concern.

The exotherm in a small part (e.g., less than about 200 grams) is often manageable because the surface to volume ratio is large, and the heat can be easily released. The exotherm in a large part (e.g., more than about 200 grams) must be specifically addressed because the heat cannot be efficiently released due to poor heat transfer in the bulk matrix. Larger parts tend to behave like an adiabatic medium, limited to no heat transfer with the outside, especially within the core of the reacting medium. As a result, a significant temperature increase can be experienced by heat-transfer limited portions of a part. In practice, once a threshold temperature is reached, the epoxy based material may start to decompose, at least partially, resulting in discoloration, in deterioration of the properties of the epoxy based material, in deterioration of the components of the mold and/or other components embedded in the epoxy base material, and, in an extreme case, resulting in carbonization of the epoxy based material, charring, or a fire.

Various modifications to and combinations of epoxy resins, hardening agents, and catalysts, or combinations thereof, have been made in an attempt to limit the exotherm during cure of an epoxy-based composition. For example, Watanabe (JP 9249741) describes an epoxy based composition with lower exotherm by mixing an epoxy resin with methyltetrahydrophthalic anhydride and a specified cure accelerator, namely 2-methylimidazole.

Mizumoto (JP 9052942) describes a one-pack epoxy based composition with lower exotherm by using a cation-polymerizable curing agent or an anion-polymerizable curing agent.

Yamamoto et al. (JP 61130333) describes a cure accelerator which, when used in combination with an epoxy resin and an amine curing agent, can lower the reaction exotherm.

Hermansen et al. (U.S. Pat. No. 5,350,779) describe epoxy-type impregnating compounds, which are useful for electrical potting or encapsulation, plastic tooling, and fiber-reinforced composites, comprising an epoxy resin component and a stoichiometric amount of a curative being a mixture of cycloaliphatic diamines, comprising from about 20 to 80 wt % of at least one sterically-hindered cycloaliphatic diamine and the balance at least one sterically-unhindered cycloaliphatic diamine.

Kimura et al. (Proc. Electr./Electron. Insul. Conf., 1975) describe the development of a novel cycloaliphatic epoxy resin with low reactivity when cured with anhydrides. Consequently the reaction exotherm is low.

Kenny (Journal of Scientific Instruments, 1965) describes the development of epoxy based compositions containing a mixture of phthalic anhydride and hexahydrophthalic anhydride used as curing agent. The exotherm is reduced because of the lower reactivity of hexahydrophthalic anhydride with the epoxy resin when compared with phthalic anhydride.

Unfortunately, such specific modifications to the epoxy resin, the hardener, or the catalyst used, or requiring a specific mixture of these to achieve a desired exotherm is extremely limiting and may not be suitable for a broad range of applications. Accordingly, there exists a need for epoxy systems that allows for a decreased exotherm suitable for use or adaptable to a wide range of epoxy-based processes and products.

### SUMMARY OF THE CLAIMED EMBODIMENTS

In one aspect, embodiments disclosed herein relate to curable epoxy-based resins having a lower peak exotherm during cure. The epoxy-based compositions having a lower peak exotherm during cure may include: at least one epoxy resin, at least one hardener, and at least one endothermic transition additive.

In another aspect, embodiments disclosed herein relate to a process for forming a curable epoxy-based composition having a lower peak exotherm, the process including: admixing at least one epoxy resin; at least one hardener; and at least one endothermic transition additive; to form a curable composition.

In another aspect, embodiments disclosed herein relate to a process for forming a thermoset resin, the process including: admixing at least one epoxy resin; at least one hardener; and at least one endothermic transition additive; to form a curable composition; and thermally curing the curable composition at a temperature of at least 60° C. to form a thermoset resin.

In another aspect, embodiments disclosed herein relate to a thermoset resin, including the reaction product of: at least one epoxy resin; at least one hardener; and at least one endothermic transition additive.

In another aspect, embodiments disclosed herein relate to epoxy-based parts formed from the above-described curable compositions and thermoset resins, where the epoxy-based part is formed using 200 grams, 500 grams, 1000 grams or more of the thermoset resin. Such parts may be produced by at least one of casting, potting, encapsulation, injection, lamination, and infusion, and may include parts such as an electrical potting, a casting, a molding, an encapsulation, a plastic tooling, and a fiber-reinforced composite.

Other aspects and advantages will be apparent from the following description and the appended claims.

### BRIEF DESCRIPTION OF DRAWINGS

FIG. 1 is a graphical comparison of the normalized heat flow as a function of temperature of an epoxy-based composition according to embodiments disclosed herein as compared to comparative examples and polyethylene powder.

### DETAILED DESCRIPTION

In one aspect, embodiments disclosed herein relate to epoxy-based compositions having a low reaction exotherm. More specifically, embodiments disclosed herein relate to epoxy-based compositions including an epoxy resin, a hardener, and an endothermic transition additive, wherein the epoxy-based composition has a lower reaction exotherm due to the presence of the endothermic phase transition additive.

As used throughout this document, the term “exotherm” is intended to mean heat of reaction experienced by the part during production. Thus, the term “maximum exotherm” is intended to mean the maximum heat of reaction experienced by the part during production. Practically, this may be assessed by measuring the maximum temperature reached in the part (typically in the core) during curing.

Throughout this invention, the terms “enthalpy of melting,” “latent heat of melting” and “heat of fusion” are intended to have the same meaning and are used interchangeably. They are each defined by the enthalpy of an endothermic phase transition of the material.

Epoxy-based compositions having a lower peak exotherm may include (a) at least one epoxy resin, (b) at least one curing agent (hardener), and (c) at least one endothermic transition additive. In other embodiments, the epoxy-based compositions disclosed herein may include (d) at least one catalyst for the reaction between the epoxy and the curing agent and (e) an inorganic filler.

In another aspect, embodiments disclosed herein provide a process for producing of an epoxy-based part, the process comprising the steps of: (i) admixing (a) an epoxy resin, (b) a curing agent, (c) at least one endothermic transition additive to produce a reaction mixture; (ii) placing the reaction mixture into a mold, and (iii) reacting the epoxy resin and the curing agent in the reaction mixture to produce a part. In other embodiments, the reaction mixture may further include (d) a catalyst for the reaction between the epoxy and the curing agent and (e) an inorganic filler.

A lower reaction exotherm for epoxy-based compositions may be achieved through the introduction of a material that acts as heat sink by undergoing an endothermic transition during the curing of the epoxy composition. An endothermic transition means a transition resulting from the absorption of heat. By adequately selecting the endothermic transition additive, the endothermic transition may occur during the epoxy reaction exotherm, such as at a temperature lower than the peak exotherm, and therefore may absorb a significant portion of the heat of reaction liberated during the process. The endothermic transition may result, for example, from the melting of the endothermic transition additive. In some embodiments, the endothermic transition additive may be a solid at ambient temperatures and pressures. In other embodiments, the endothermic transition additive may be a highly crystalline or a semi-crystalline polymer.

The enthalpy of useful endothermic transition additives during the endothermic transition may be at least 50 J/g in some embodiments, and may significantly reduce the temperature of the peak exotherm. In other embodiments, the enthalpy of the endothermic transition may be in the range of about 50 to about 600 J/g; from about 60 to about 400 J/g in other embodiments; and from about 80 to about 250 J/g in yet other embodiments. For a given filler material, the enthalpy of endothermic phase transition can be readily determined by a person of ordinary skill in the art. Specifically, the test method for Heats of Fusion and Crystallization may be determined by Differential Scanning calorimetry (DSC), pursuant to ASTM E793.

Endothermic transition additives may be used in the form of films, fibers, particles, powders, spheres, microspheres, granules, and the like. The size of the particulate material is not specifically restricted; however, the size of the endothermic transition additive should be selected so as to not have a detrimental effect on processing or on the final mechanical properties (i.e., after cure) of the epoxy based composition. The endothermic transition additive may have an average particle size of less than about 1 mm in some embodiments; between about 5 nm and 500 microns in other embodiments; between 10 nm and 300 microns in other embodiments; and between 100 nm and 100 microns in other embodiments, and between 500 nm and 20 microns in yet other embodiments.

Such epoxy-based compositions, having a lower peak exotherm due to the presence of an endothermic transition additive, may be suitable for the production of large or massive epoxy based parts. For example, the amount of epoxy-based composition that may be used to produce a part can be larger than about 200 g, larger than about 500 g, or larger than about 1 kg in various embodiments.

While not wishing to be bound by any particular theory or mode of action, it is believed that, in most cases, the endothermic transition will occur by the solid endothermic transition additive absorbing at least a portion of the heat of reaction liberated during production of the epoxy-based polymer, resulting in the melting and/or other endothermic transition of the solid material. As the part cools down after the maximum temperature is reached, the additive material may solidify again. Thus, while it is believed that the total heat of reaction of the epoxy and curing agent remains substantially unchanged, the additive material is believed to act as an active heat sink (i.e., the material is active in the sense that it undergoes some form of phase transition before the maximum exotherm of the reaction) which quickly absorbs a portion of the heat of reaction. The net result is a lowering of the maximum exotherm (or maximum temperature) experienced by the part during production and possibly more uniform and/or improved properties due to a reduction in the temperature gradient experienced by the part.

The maximum exotherm of an epoxy-based composition may be determined as follows. The epoxy based composition (typically including an epoxy resin, a hardener for the epoxy resin, an endothermic transition additive, optionally a catalyst for the reaction between the epoxy resins and the hardener, and optionally other additives or fillers) is thoroughly mixed and then poured into a container. A thermocouple probe is inserted into the container close to its geometric center, and the temperature is monitored during the reaction of the epoxy and the hardener. The maximum exotherm temperature is determined by the highest temperature recorded during the test.

In some embodiments, the temperature of the reaction exotherm may be lowered by at least about 5° C.; by at least about 10° C. in other embodiments; by at least about 20° C. in other embodiments; and by at least about 30° C. in yet other embodiments, when compared with the same epoxy based formulation without an endothermic transition additive. In other embodiments, the temperature of the reaction exotherm, when measured in ° C., is lowered by at least about 5%; by at least about 10% in other embodiments; by at least about 20% in other embodiments; and by at least about 30% in yet other embodiments, when compared with the same epoxy-based formulation without an endothermic transition additive.

The endothermic transition additive may be selected such that it undergoes a transition involving an endothermic phase change (i.e., a phase change as a result of absorbing heat) at a temperature below the maximum exotherm the epoxy based composition would experience during production in the absence of the endothermic transition additive. In some embodiments, the endothermic transition additive undergoes a transition involving an endothermic phase change at a temperature at least 5° C. below the maximum exotherm the epoxy based composition would experience during production in the absence of the endothermic transition additive; at least 10° C. below the maximum exotherm in other embodiments; at least 20° C. below the maximum exotherm in other embodiments; and at least 50° C. below the maximum exotherm in other embodiments. In yet other embodiments, the endothermic transition additive or a mixture of endothermic transition additives may undergo more than one endothermic transition at various temperatures less then the maximum exotherm the epoxy based composition would experience during production in the absence of the endothermic transition additive.

In some embodiments, the onset temperature of the endothermic transition may be lower than about 160° C.; in other embodiments, the endothermic transition may occur at a temperature lower than about 140° C.; lower than 120° C. in other embodiments; lower than about 100° C. in other embodiments; higher than 0° C. in other embodiments; higher than 25° C. in other embodiments; higher than about 40° C. in other embodiments; and higher than about 50° C. in yet other embodiments.

The filler material may be crystalline or non-crystalline. Highly crystalline and/or partially crystalline (semi-crystalline) materials may also be used, such as highly crystalline polymers and semi-crystalline polymers.

Epoxy-based compositions disclosed herein may include endothermic transition additives in an amount less than about 50% by weight of the epoxy-based composition; from about 1% to about 40% by weight in other embodiments; from about 5% to about 35% by weight in other embodiments; and between about 10% and about 30% by weight in yet other embodiments, where the above weight percentages are based on a total weight of epoxy resin, hardener, and endothermic transition additive. The amount of endothermic transition additive used may be influenced by a number of factors, including the heat capacity of the specific endothermic transition additive, the maximum exotherm of the epoxy-based composition without an endothermic transition additive, and the viscosity of the reaction mixture, especially at higher loadings of the endothermic transition additive.

In addition to the epoxy resin, the endothermic transition additives, and hardeners, as mentioned above, epoxy-based compositions disclosed herein may also include catalysts, flame retardants, and other additives. Each of these components useful in epoxy-based compositions is described in more detail below.

Epoxy Resins

The epoxy resins used in embodiments disclosed herein may vary and include conventional and commercially available epoxy resins, which may be used alone or in combinations of two or more. In choosing epoxy resins for compositions disclosed herein, consideration should not only be given to properties of the final product, but also to viscosity and other properties that may influence the processing of the resin composition.

The epoxy resin component may be any type of epoxy resin, including any material containing one or more reactive oxirane groups, referred to herein as “epoxy groups” or “epoxy functionality.” Epoxy resins useful in embodiments disclosed herein may include mono-functional epoxy resins, multi- or poly-functional epoxy resins, and combinations thereof. Monomeric and polymeric epoxy resins may be aliphatic, cycloaliphatic, aromatic, or heterocyclic epoxy resins. The polymeric epoxies include linear polymers having terminal epoxy groups (a diglycidyl ether of a polyoxyalkylene glycol, for example), polymer skeletal oxirane units (polybutadiene polyepoxide, for example) and polymers having pendant epoxy groups (such as a glycidyl methacrylate polymer or copolymer, for example). The epoxies may be pure compounds, but are generally mixtures or compounds containing one, two or more epoxy groups per molecule. In some embodiments, epoxy resins may also include reactive —OH groups, which may react at higher temperatures with anhydrides, organic acids, amino resins, phenolic resins, or with epoxy groups (when catalyzed) to result in additional crosslinking.

In general, the epoxy resins may be glycidated resins, cycloaliphatic resins, epoxidized oils, and so forth. The glycidated resins are frequently the reaction product of epichlorohydrin and a bisphenol compound, such as bisphenol A; C₄ to C₂₈ alkyl glycidyl ethers; C₂ to C₂₈ alkyl- and alkenyl-glycidyl esters; C₁ to C₂₈ alkyl-, mono- and poly-phenol glycidyl ethers; polyglycidyl ethers of polyvalent phenols, such as pyrocatechol, resorcinol, hydroquinone, 4,4′-dihydroxydiphenyl methane (or bisphenol F), 4,4′-dihydroxy-3,3′-dimethyldiphenyl methane, 4,4′-dihydroxydiphenyl dimethyl methane (or bisphenol A), 4,4′-dihydroxydiphenyl methyl methane, 4,4′-dihydroxydiphenyl cyclohexane, 4,4′-dihydroxy-3,3′-dimethyldiphenyl propane, 4,4′-dihydroxydiphenyl sulfone, and tris(4-hydroxyphynyl)methane; polyglycidyl ethers of the chlorination and bromination products of the above-mentioned diphenols; polyglycidyl ethers of novolacs; polyglycidyl ethers of diphenols obtained by esterifying ethers of diphenols obtained by esterifying salts of an aromatic hydrocarboxylic acid with a dihaloalkane or dihalogen dialkyl ether; polyglycidyl ethers of polyphenols obtained by condensing phenols and long-chain halogen paraffins containing at least two halogen atoms. Other examples of epoxy resins useful in embodiments disclosed herein include bis-4,4′-(1-methylethylidene)phenol diglycidyl ether and (chloromethyl)oxirane Bisphenol A diglycidyl ether.

In some embodiments, the epoxy resin may include glycidyl ether type; glycidyl-ester type; alicyclic type; heterocyclic type, and halogenated epoxy resins, etc. Non-limiting examples of suitable epoxy resins may include cresol novolac epoxy resin, phenolic novolac epoxy resin, biphenyl epoxy resin, hydroquinone epoxy resin, stilbene epoxy resin, and mixtures and combinations thereof.

Suitable polyepoxy compounds may include resorcinol diglycidyl ether (1,3-bis-(2,3-epoxypropoxy)benzene), diglycidyl ether of bisphenol A (2,2-bis(p-(2,3-epoxypropoxy)phenyl)propane), triglycidyl p-aminophenol (4-(2,3-epoxypropoxy)-N,N-bis(2,3-epoxypropyl)aniline), diglycidyl ether of bromobisphenol A (2,2-bis(4-(2,3-epoxypropoxy)-3-bromo-phenyl)propane), diglycidyl ether of Bisphenol F (2,2-bis(p-(2,3-epoxypropoxy)phenyl)methane), triglycidyl ether of meta- and/or para-aminophenol (3-(2,3-epoxypropoxy)N,N-bis(2,3-epoxypropyl)aniline), and tetraglycidyl methylene dianiline (N,N,N′,N′-tetra(2,3-epoxypropyl) 4,4′-diaminodiphenyl methane), and mixtures of two or more polyepoxy compounds. A more exhaustive list of useful epoxy resins found may be found in Lee, H. and Neville, K., Handbook of Epoxy Resins, McGraw-Hill Book Company, 1982 reissue.

Other suitable epoxy resins include polyepoxy compounds based on aromatic amines and epichlorohydrin, such as N,N′-diglycidyl-aniline; N,N′-dimethyl-N,N′-diglycidyl-4,4′-diaminodiphenyl methane; N,N,N′,N′-tetraglycidyl-4,4′-diaminodiphenyl methane; N-diglycidyl-4-aminophenyl glycidyl ether; and N,N,N′,N′-tetraglycidyl-1,3-propylene bis-4-aminobenzoate. Epoxy resins may also include glycidyl derivatives of one or more of: aromatic diamines, aromatic monoprimary amines, aminophenols, polyhydric phenols, polyhydric alcohols, polycarboxylic acids.

Useful epoxy resins include, for example, polyglycidyl ethers of polyhydric polyols, such as ethylene glycol, triethylene glycol, 1,2-propylene glycol, 1,5-pentanediol, 1,2,6-hexanetriol, glycerol, and 2,2-bis(4-hydroxy cyclohexyl)propane; polyglycidyl ethers of aliphatic and aromatic polycarboxylic acids, such as, for example, oxalic acid, succinic acid, glutaric acid, terephthalic acid, 2,6-naphthalene dicarboxylic acid, and dimerized linoleic acid; polyglycidyl ethers of polyphenols, such as, for example, bis-phenol A, bis-phenol F, 1,1-bis(4-hydroxyphenyl)ethane, 1,1-bis(4-hydroxyphenyl)isobutane, and 1,5-dihydroxy naphthalene; modified epoxy resins with acrylate or urethane moieties; glycidylamine epoxy resins; and novolac resins.

The epoxy compounds may be cycloaliphatic or alicyclic epoxides. Examples of cycloaliphatic epoxides include diepoxides of cycloaliphatic esters of dicarboxylic acids such as bis(3,4-epoxycyclohexylmethyl)oxalate, bis(3,4-epoxycyclohexylmethyl)adipate, bis(3,4-epoxy-6-methylcyclohexylmethyl)adipate, bis(3,4-epoxycyclohexylmethyl)pimelate; vinylcyclohexene diepoxide; limonene diepoxide; dicyclopentadiene diepoxide; and the like. Other suitable diepoxides of cycloaliphatic esters of dicarboxylic acids are described, for example, in U.S. Pat. No. 2,750,395.

Other cycloaliphatic epoxides include 3,4-epoxycyclohexylmethyl-3,4-epoxycyclohexane carboxylates such as 3,4-epoxycyclohexylmethyl-3,4-epoxycyclohexane carboxylate; 3,4-epoxy-1-methylcyclohexyl-methyl-3,4-epoxy-1-methylcyclohexane carboxylate; 6-methyl-3,4-epoxycyclohexylmethylmethyl-6-methyl-3,4-epoxycyclohexane carboxylate; 3,4-epoxy-2-methylcyclohexylmethyl-3,4-epoxy-2-methylcyclohexane carboxylate; 3,4-epoxy-3-methylcyclohexyl-methyl-3,4-epoxy-3-methylcyclohexane carboxylate; 3,4-epoxy-5-methylcyclohexyl-methyl-3,4-epoxy-5-methylcyclohexane carboxylate and the like. Other suitable 3,4-epoxycyclohexylmethyl-3,4-epoxycyclohexane carboxylates are described, for example, in U.S. Pat. No. 2,890,194.

Further epoxy-containing materials which are particularly useful include those based on glycidyl ether monomers. Examples are di- or polyglycidyl ethers of polyhydric phenols obtained by reacting polyhydric phenol with an excess of chlorohydrin such as epichlorohydrin. Such polyhydric phenols include resorcinol, bis(4-hydroxyphenyl)methane (known as bisphenol F), 2,2-bis(4-hydroxyphenyl)propane (known as bisphenol A), 2,2-bis(4′-hydroxy-3′,5′-dibromophenyl)propane, 1,1,2,2-tetrakis(4′-hydroxy-phenyl)ethane or condensates of phenols with formaldehyde that are obtained under acid conditions such as phenol novolacs and cresol novolacs. Examples of this type of epoxy resin are described in U.S. Pat. No. 3,018,262. Other examples include di- or polyglycidyl ethers of polyhydric alcohols such as 1,4-butanediol, or polyalkylene glycols such as polypropylene glycol and di- or polyglycidyl ethers of cycloaliphatic polyols such as 2,2-bis(4-hydroxycyclohexyl)propane. Other examples are monofunctional resins such as cresyl glycidyl ether or butyl glycidyl ether.

Other classes of epoxy compounds include polyglycidyl esters and poly(beta-methylglycidyl) esters of polyvalent carboxylic acids such as phthalic acid, terephthalic acid, tetrahydrophthalic acid or hexahydrophthalic acid. A further class of epoxy compounds are N-glycidyl derivatives of amines, amides and heterocyclic nitrogen bases such as N,N-diglycidyl aniline, N,N-diglycidyl toluidine, N,N,N′,N′-tetraglycidyl bis(4-aminophenyl)methane, triglycidyl isocyanurate, N,N′-diglycidyl ethyl urea, N,N′-diglycidyl-5,5-dimethylhydantoin, and N,N′-diglycidyl-5-isopropylhydantoin.

Still other epoxy-containing materials are copolymers of acrylic acid esters of glycidol such as glycidylacrylate and glycidylmethacrylate with one or more copolymerizable vinyl compounds. Examples of such copolymers are 1:1 styrene-glycidylmethacrylate, 1:1 methylmethacrylate-glycidylacrylate and a 62.5:24:13.5 methylmethacrylate-ethyl acrylate-glycidylmethacrylate.

Epoxy compounds that are readily available include octadecylene oxide; glycidylmethacrylate; diglycidyl ether of bisphenol A; D.E.R. 330, D.E.R. 331, D.E.R. 332 and D.E.R. 383 from The Dow Chemical Company, Midland, Mich.; vinylcyclohexene dioxide; 3,4-epoxycyclohexylmethyl-3,4-epoxycyclohexane carboxylate; 3,4-epoxy-6-methylcyclohexyl-methyl-3,4-epoxy-6-methylcyclohexane carboxylate; bis(3,4-epoxy-6-methylcyclohexylmethyl)adipate; bis(2,3-epoxycyclopentyl)ether; aliphatic epoxy modified with polypropylene glycol; dipentene dioxide; epoxidized polybutadiene; silicone resin containing epoxy functionality; flame retardant epoxy resins (such as a brominated bisphenol type epoxy resin available under the tradename D.E.R. 530, D.E.R. 539, D.E.R. 542, D.E.R. 560, and D.E.R. 592, available from The Dow Chemical Company, Midland, Mich.); 1,4-butanediol diglycidyl ether of phenol-formaldehyde novolac (such as those available under the tradenames D.E.N. 431 and D.E.N. 438 available from The Dow Chemical Company, Midland, Mich.); and resorcinol diglycidyl ether Although not specifically mentioned, other epoxy resins under the tradename designations D.E.R. and D.E.N. available from the Dow Chemical Company may also be used. In some embodiments, epoxy resin compositions may include epoxy resins formed by reaction of a diglycidyl ether of bisphenol A with bisphenol A.

Other suitable epoxy resins are disclosed in U.S. Pat. No. 5,112,932, which is incorporated herein by reference. Such epoxy resins may include epoxy terminated polyoxazolidone-containing compounds, including, for example, the reaction product of a polyepoxide compound with a polyisocyanate compound. Polyepoxides disclosed may include diglycidyl ether of 2,2-bis(4-hydroxyphenyl) propane (generally referred to as bisphenol A) and diglycidyl ether of 2,2-bis(3,5-dibromo-4-hydroxyphenyl) propane (generally referred to as tetrabromobisphenol A). Suitable polyisocyanates include 4,4′-methylene bis(phenyl)socyanate) (MDI) and isomers thereof, higher functional homologs of MDI (commonly designated as “polymeric MDI”), toluene diisocyanate (TDI) such as 2,4-toluene diisocyanate and 2,6-toluene diisocyanate, m-xylylene diisocyanate, hexamethylene diisocyanate (HMDI) and isophoronediisocyanate.

Other suitable epoxy resins are disclosed in, for example, U.S. Pat. Nos. 7,163,973, 6,887,574, 6,632,893, 6,242,083, 7,037,958, 6,572,971, 6,153,719, and 5,405,688, PCT Publication WO 2006/052727, and U.S. Patent Application Publication Nos. 20060293172 and 20050171237, each of which is hereby incorporated herein by reference.

Endothermic Transition Additive

As described above, a lower reaction exotherm for epoxy-based compositions may be achieved through the introduction of a material that acts as heat sink by undergoing an endothermic transition during the curing of the epoxy composition. The endothermic transition may result, for example, from the melting of the endothermic transition additive. In some embodiments, the endothermic transition additive may be a solid at ambient temperatures and pressures. In other embodiments, the endothermic transition additive may be a highly crystalline or a semi-crystalline polymer.

In some embodiments, endothermic transition additives may be crystalline in nature. In this regard, it should be appreciated that the term “crystalline,” when used in this specification in reference to the endothermic transition additive, is intended to have a broad meaning and covers partially crystalline (i.e. semi-crystalline) and high crystalline solids. While not wishing to be bound by any particular theory or mode of action, it is believed that at least some of the advantages of embodiments disclosed herein relate to the heat absorption capability of the crystalline endothermic transition additive. Specifically, a crystalline endothermic transition additive should have a melting below the maximum temperature reached by the epoxy based composition during production, as discussed above. Thus a portion of the heat liberated during the reaction or the epoxy and the hardener is absorbed by the crystalline endothermic transition additive, typically resulting in melting of the endothermic transition additive, instead of raising the exotherm of the epoxy-based composition. As the crystalline endothermic transition additive is substantially uniformly distributed throughout the epoxy-based composition matrix, the result is an overall lowering of the maximum exotherm experienced by the epoxy-based composition during reaction or curing. The lower exotherm may significantly improve the safety of production and/or obviate deterioration of various physical properties. As the epoxy based matrix cools down after production, the filler material may re-crystallize or re-solidify.

In some embodiments, the endothermic transition additive is organic, such as an organic polymer, including thermoplastic materials. Non-limiting examples of useful thermoplastic polymers include: polyethylene, polypropylene, chlorinated polyethylene, ethylene-vinyl-acetate (EVA), polyethylethacrylate (PEEA), acetal, nylon 11, polyvinylidenechloride, polybutene, epichlorohydrin (ECO) plastic rubber-modified analogues copolymers, and mixtures thereof. In some embodiments, the endothermic transition additive includes polyethylene, polypropylene, and mixtures thereof. In yet other embodiments, the endothermic transition additive is a crystalline polyethylene. Non-limiting examples of other useful organic materials include paraffins, fatty acids, alcohols, tetradecanoic acid myristamide, salts of fatty acids (e.g., calcium stearate, zinc stearate, zinc laurate, and the like).

Alternatively, the endothermic transition additive may be inorganic. Non-limiting examples of useful inorganic materials may include sodium thiosulfate pentahydrate, sodium acetate trihydrate, sodium sulfate decahydrate, barium hydroxide hydrate, nickel nitrate tetrahydrate, zinc nitrate hexahydrate, blends thereof, alloys thereof, and eutectic mixtures thereof.

Modified filler materials may also be used. For example, it is known to modify the surface of particles by exposing them to chemical treatment, ultraviolet, electron beam, and similar treatments to, for example, improve adhesion of the particles in the matrix in which there are being dispersed.

To be useful in an epoxy-based composition, the onset of the endothermic transition must take place at a temperature which is lower than the temperature of the peak exotherm due to the exothermic reaction. By adequately selecting the material, the endothermic transition occurs during the reaction exotherm and therefore absorbs a significant portion of the heat of reaction liberated during the process.

Hardeners/Curing Agents

Hardeners or curing agents may also be provided for promoting crosslinking of the epoxy resin composition to form a polymer composition. As with the epoxy resins, the hardeners and curing agents may be used individually or as a mixture of two or more. The curing agent component (also referred to as a hardener or cross-linking agent) may include any compound having an active group being reactive with the epoxy group of the epoxy resin. The curing agents may include nitrogen-containing compounds such as amines and their derivatives; oxygen-containing compounds such as carboxylic acid terminated polyesters, anhydrides, phenol novolacs, bisphenol-A novolacs, DCPD-phenol condensation products, brominated phenolic oligomers, amino-formaldehyde condensation products, phenol, bisphenol A and cresol novolacs, phenolic-terminated epoxy resins; sulfur-containing compounds such as polysulfides, polymercaptans; and catalytic curing agents such tertiary amines, Lewis acids, Lewis bases and combinations of two or more of the above curing agents. Practically, polyamines, diaminodiphenylsulfone and their isomers, aminobenzoates, various acid anhydrides, phenol-novolac resins and cresol-novolac resins, for example, may be used, but the present disclosure is not restricted to the use of these compounds.

Other embodiments of cross-linkers that may be used are described in U.S. Pat. No. 6,613,839, and include, for example, copolymers of styrene and maleic anhydride having a molecular weight (M_{w}) in the range of from 1500 to 50,000 and an anhydride content of more than 15 percent.

Other components that may be useful in the compositions disclosed herein include curing catalysts. Examples of curing catalyst include imidazole derivatives, tertiary amines, and organic metallic salts. Other examples of such curing catalysts include free radical initiators, such as azo compounds including azoisobutyronitrile, and organic peroxides, such as tertiary-butyl perbenzoate, tertiary-butyl peroctoate, and benzoyl peroxide; methyl ethyl ketone peroxide, acetoacetic peroxide, cumene hydroperoxide, cyclohexanone hydroperoxide, dicumyl peroxide, and mixtures thereof. Methyl ethyl ketone peroxide and benzoyl peroxide are preferably used in the present invention.

In some embodiments, curing agents may include primary and secondary polyamines and their adducts, anhydrides, and polyamides. For example, polyfunctional amines may include aliphatic amine compounds such as diethylene triamine (D.E.H. 20, available from The Dow Chemical Company, Midland, Mich.), triethylene tetramine (D.E.H. 24, available from The Dow Chemical Company, Midland, Mich.), tetraethylene pentamine (D.E.H. 26, available from The Dow Chemical Company, Midland, Mich.), as well as adducts of the above amines with epoxy resins, diluents, or other amine-reactive compounds. Aromatic amines, such as metaphenylene diamine and diamine diphenyl sulfone, aliphatic polyamines, such as amino ethyl piperazine and polyethylene polyamine, and aromatic polyamines, such as metaphenylene diamine, diamino diphenyl sulfone, and diethyltoluene diamine, may also be used.

Anhydride curing agents may include, for example, nadic methyl anhydride, hexahydrophthalic anhydride, trimellitic anhydride, dodecenyl succinic anhydride, phthalic anhydride, methyl hexahydrophthalic anhydride, tetrahydrophthalic anhydride, and methyl tetrahydrophthalic anhydride, among others. Anhydride curing agents may also include copolymers of styrene and maleic acid anhydrides and other anhydrides as described in U.S. Pat. No. 6,613,839, which is incorporated herein by reference.

In some embodiments, the phenol novolac hardener may contain a biphenyl or naphthyl moiety. The phenolic hydroxy groups may be attached to the biphenyl or naphthyl moiety of the compound. This type of hardener may be prepared, for example, according to the methods described in EP915118A1. For example, a hardener containing a biphenyl moiety may be prepared by reacting phenol with bismethoxy-methylene biphenyl.

In other embodiments, curing agents may include boron trifluoride monoethylamine, and diaminocyclohexane. Curing agents may also include imidazoles, their salts, and adducts. These epoxy curing agents are typically solid at room temperature. One example of suitable imidazole curing agents includes 2-phenylimidazole; other suitable imidazole curing agents are disclosed in EP906927A1. Other curing agents include aromatic amines, aliphatic amines, anhydrides, and phenols.

In some embodiments, the curing agents may be an amino compound having a molecular weight up to 500 per amino group, such as an aromatic amine or a guanidine derivative. Examples of amino curing agents include 4-chlorophenyl-N,N-dimethyl-urea and 3,4-dichlorophenyl-N,N-dimethyl-urea.

Other examples of curing agents useful in embodiments disclosed herein include: 3,3′- and 4,4′-diaminodiphenylsulfone; methylenedianiline; bis(4-amino-3,5-dimethylphenyl)-1,4-diisopropylbenzene available as EPON 1062 from Shell Chemical Co.; and bis(4-aminophenyl)-1,4-diisopropylbenzene available as EPON 1061 from Shell Chemical Co.

Thiol curing agents for epoxy compounds may also be used, and are described, for example, in U.S. Pat. No. 5,374,668. As used herein, “thiol” also includes polythiol or polymercaptan curing agents. Illustrative thiols include aliphatic thiols such as methanedithiol, propanedithiol, cyclohexanedithiol, 2-mercaptoethyl-2,3-dimercaptosuccinate, 2,3-dimercapto-1-propanol(2-mercaptoacetate), diethylene glycol bis(2-mercaptoacetate), 1,2-dimercaptopropyl methyl ether, bis(2-mercaptoethyl)ether, trimethylolpropane tris(thioglycolate), pentaerythritol tetra(mercaptopropionate), pentaerythritol tetra(thioglycolate), ethyleneglycol dithioglycolate, trimethylolpropane tris(beta-thiopropionate), tris-mercaptan derivative of tri-glycidyl ether of propoxylated alkane, and dipentaerythritol poly(beta-thiopropionate); halogen-substituted derivatives of the aliphatic thiols; aromatic thiols such as di-, tris- or tetra-mercaptobenzene, bis-, tris- or tetra-(mercaptoalkyl)benzene, dimercaptobiphenyl, toluenedithiol and naphthalenedithiol; halogen-substituted derivatives of the aromatic thiols; heterocyclic ring-containing thiols such as amino-4,6-dithiol-sym-triazine, alkoxy-4,6-dithiol-sym-triazine, aryloxy-4,6-dithiol-sym-triazine and 1,3,5-tris(3-mercaptopropyl)isocyanurate; halogen-substituted derivatives of the heterocyclic ring-containing thiols; thiol compounds having at least two mercapto groups and containing sulfur atoms in addition to the mercapto groups such as bis-, tris- or tetra(mercaptoalkylthio)benzene, bis-, tris- or tetra(mercaptoalkylthio)alkane, bis(mercaptoalkyl)disulfide, hydroxyalkylsulfidebis(mercaptopropionate), hydroxyalkylsulfidebis(mercaptoacetate), mercaptoethyl ether bis(mercaptopropionate), 1,4-dithian-2,5-diolbis(mercaptoacetate), thiodiglycolic acid bis(mercaptoalkyl ester), thiodipropionic acid bis(2-mercaptoalkyl ester), 4,4-thiobutyric acid bis(2-mercaptoalkyl ester), 3,4-thiophenedithiol, bismuththiol and 2,5-dimercapto-1,3,4-thiadiazol.

The curing agent may also be a nucleophilic substance such as an amine, a tertiary phosphine, a quaternary ammonium salt with a nucleophilic anion, a quaternary phosphonium salt with a nucleophilic anion, an imidazole, a tertiary arsenium salt with a nucleophilic anion, and a tertiary sulfonium salt with a nucleophilic anion.

Aliphatic polyamines that are modified by adduction with epoxy resins, acrylonitrile, or (meth)acrylates may also be utilized as curing agents. In addition, various Mannich bases can be used. Aromatic amines wherein the amine groups are directly attached to the aromatic ring may also be used.

Quaternary ammonium salts with a nucleophilic anion useful as a curing agent in embodiments disclosed herein may include tetraethyl ammonium chloride, tetrapropyl ammonium acetate, hexyl trimethyl ammonium bromide, benzyl trimethyl ammonium cyanide, cetyl triethyl ammonium azide, N,N-dimethylpyrrolidinium cyanate, N-methylpyridinium phenolate, N-methyl-o-chloropyridinium chloride, methyl viologen dichloride and the like.

In some embodiments, at least one cationic photoinitiator may be used. Cationic photoinitiators include compounds that decompose when exposed to electromagnetic radiation of a particular wavelength or range of wavelengths to form a cationic species that may catalyze the polymerization reaction, such as between an epoxide group and a hydroxyl group. That cationic species may also catalyze the reaction of epoxide groups with other epoxide-reactive species contained in the curable composition (such as other hydroxyl groups, amine groups, phenolic groups, mercaptan groups, anhydride groups, carboxylic acid groups and the like). Examples of cationic photoinitiators include diaryliodonium salts and triarylsulfonium salts. For example, a diaryliodonium salt type of photoinitiator is available from Ciba-Geigy under the trade designation IRGACURE 250. A triarylsulfonium-type photoinitiator is available from The Dow Chemical Company as CYRACURE 6992. The cationic photoinitiator may be used in a catalytically effective amount, and may constitute up to about 10 weight percent of the curable composition

Catalysts

In some embodiments, a catalyst may be used to promote the reaction between the epoxy resin component and the curing agent or hardener, including dicyandiamide and the phenolic hardener described above. Catalysts may include a Lewis acid, for example boron trifluoride, conveniently as a derivative with an amine such as piperidine or methyl ethylamine. Catalysts may also be basic, such as, for example, an imidazole or an amine. Other catalysts may include other metal halide Lewis acids, including stannic chloride, zinc chloride, and the like, metal carboxylate-salts, such as stannous octoate and the like; benzyl dimethylamine; dimethyl aminomethyl phenol; and amines, such as triethylamine, imidazole derivatives, and the like.

Tertiary amine catalysts are described, for example, in U.S. Pat. No. 5,385,990, incorporated herein by reference. Illustrative tertiary amines include methyldiethanolamine, triethanolamine, diethylaminopropylamine, benzyldimethyl amine, m-xylylenedi(dimethylamine), N,N′-dimethylpiperazine, N-methylpyrrolidine, N-methyl hydroxypiperidine, N,N,N′N′-tetramethyldiaminoethane, N,N,N′,N′,N′-pentamethyldiethylenetriamine, tributyl amine, trimethyl amine, diethyldecyl amine, triethylene diamine, N-methyl morpholine, N,N,N′N′-tetramethyl propane diamine, N-methyl piperidine, N,N′-dimethyl-1,3-(4-piperidino)propane, pyridine and the like. Other tertiary amines include 1,8-diazobicyclo[5.4.0]undec-7-ene, 1,8-diazabicyclo[2.2.2]octane, 4-dimethylaminopyridine, 4-(N-pyrrolidino)pyridine, triethyl amine and 2,4,6-tris(dimethylaminomethyl)phenol.

Flame Retardant Additives

The epoxy-based compositions described herein may be used in formulations that contain brominated and non-brominated flame retardants. Specific examples of brominated additives include tetrabromobisphenol A (TBBA) and materials derived therefrom: TBBA-diglycidyl ether, reaction products of bisphenol A or TBBA with TBBA-diglycidyl ether, and reaction products of bisphenol A diglycidyl ether with TBBA.

Non-brominated flame retardants include the various materials derived from DOP (9,10-dihydro-9-oxa-10-phosphaphenanthrene 10-oxide) such as DOP-hydroquinone (10-(2′,5′-dihydroxyphenyl)-9,10-dihydro-9-oxa-10-phosphaphenanthrene 10-oxide), condensation products of DOP with glycidyl ether derivatives of novolacs, and inorganic flame retardants such as aluminum trihydrate and aluminum phosphinite.

Optional Additives

Curable and thermoset compositions disclosed herein may optionally include conventional additives and fillers. Additives and fillers may include, for example, other flame retardants, boric acid, silica, glass, talc, metal powders, titanium dioxide, wetting agents, pigments, coloring agents, mold release agents, coupling agents, ion scavengers, UV stabilizers, flexibilizing agents, toughening agents, and tackifying agents. Additives and fillers may also include fumed silica, aggregates such as glass beads, polytetrafluoroethylene, polyol resins, polyester resins, phenolic resins, graphite, molybdenum disulfide, abrasive pigments, viscosity reducing agents, boron nitride, mica, nucleating agents, and stabilizers, among others. Fillers and modifiers may be preheated to drive off moisture prior to addition to the epoxy resin composition. Additionally, these optional additives may have an effect on the properties of the composition, before and/or after curing, and should be taken into account when formulating the composition and the desired reaction product. Curable compositions disclosed herein may also optionally contain other additives of a generally conventional type including for example, stabilizers, other organic or inorganic additives, pigments, wetting agents, flow modifiers, UV light blockers, and fluorescent additives. These additives may be present in amounts of from 0 to 5 weight-percent in some embodiments, and less than 3 weight percent in other embodiments. Examples of suitable additives are also described in U.S. Pat. No. 5,066,735 and PCT/US2005/017954.

Organic solvents may be used in some embodiments, including ketones, such as methyl ethyl ketone (MEK), glycol ethers, such as propylene glycol methyl ether, and alcohols, such as methanol. In some embodiments, minor amounts of higher molecular weight, relatively non-volatile monoalcohols, polyols, and other epoxy- or isocyanato-reactive diluents may also be used, if desired, to serve as plasticizers in the curable and thermoset compositions disclosed herein.

Curable Compositions

Curable compositions may be formed by combining an epoxy resin, a hardener, and an endothermic transition additive, as described above. Curable compositions described herein may also be formed by combining an epoxy resin, a hardener, and an endothermic transition additive along with additional hardeners, additives, catalysts, and other optional components. For example, in some embodiments, a curable composition may be formed by admixing an epoxy resin composition, a hardener, and an endothermic transition additive, to form a mixture. The proportions of the epoxy resin and the hardener may depend, in part, upon the properties desired in the curable composition or cured compositions to be produced, the desired cure response of the composition, and the desired storage stability of the composition (desired shelf life). In other embodiments, a process to form a curable composition may include one or more of the steps of forming an epoxy resin or prepolymer composition, admixing a hardener, admixing an endothermic transition additive, admixing additional hardeners or catalysts, admixing a flame retardant, and admixing additives.

In some embodiments, the epoxy resin may be present in the curable composition in an amount ranging from 0.1 to 99 weight percent of the curable composition. In other embodiments, the epoxy composition may range from 0.1 to 50 weight percent of the curable composition; from 15 to 45 weight percent in other embodiments; and from 25 to 40 weight percent in yet other embodiments. In other embodiments, the epoxy resin may be present in the range from 30 to 99 weight percent of the curable composition; from 50 to 99 weight percent in other embodiments; from 60 to 95 weight percent in other embodiments; and from 70 to 90 weight percent in yet other embodiments.

In some embodiments, curable compositions may include from about 30 to about 98 volume percent epoxy resin. In other embodiments, curable compositions may include 65 to 95 volume percent epoxy resin; from 70 to 90 volume percent epoxy resin in other embodiments; from 30 to 65 volume percent epoxy resin in other embodiments; and from 40 to 60 volume percent epoxy resin in yet other embodiments.

In some embodiments, hardeners may be present in the curable composition in an amount ranging from 0.01 weight percent to 60 weight percent. In other embodiments, the hardener may be present in an amount ranging from 0.1 weight percent to 55 weight percent; from 0.5 weight percent to 50 weight percent in other embodiments; and from 1 to 45 weight percent in yet other embodiments.

In some embodiments, a catalyst may be present in the curable composition in an amount ranging from 0.01 weight percent to 10 weight percent. In other embodiments, the catalyst may be present in an amount ranging from 0.1 weight percent to 8 weight percent; from 0.5 weight percent to 6 weight percent in other embodiments; and from 1 to 4 weight percent in yet other embodiments.

In a class of embodiments, curable composition described herein may include: 30 to 99 weight percent of an epoxy resin; 1 to 40 weight percent of a hardener; and up to 45 weight percent of an endothermic transition additive, wherein the weight percentages given are based on the combined weight of the hardener, the epoxy resin, and the endothermic transition additive.

Curable compositions may also include from about 0.1 to about 50 volume percent optional additives in some embodiments. In other embodiments, curable compositions may include from about 0.1 to about 5 volume percent optional additives; and from about 0.5 to about 2.5 volume percent optional additives in yet other embodiments.

Substrates

The curable compositions described above may be disposed on a substrate or in a mold and cured. The substrate is not subject to particular limitation. As such, substrates may include metals, such as stainless steel, iron, steel, copper, zinc, tin, aluminum, alumite and the like; alloys of such metals, and sheets which are plated with such metals and laminated sheets of such metals. Substrates may also include polymers, glass, and various fibers, such as, for example, carbon/graphite; boron; quartz; aluminum oxide; glass such as E glass, S glass, S-2 GLASS or C glass; and silicon carbide or silicon carbide fibers containing titanium. Commercially available fibers may include: organic fibers, such as KEVLAR from DuPont; aluminum oxide-containing fibers, such as NEXTEL fibers from 3M; silicon carbide fibers, such as NICALON from Nippon Carbon; and silicon carbide fibers containing titanium, such as TYRRANO from Ube. In particular embodiments, the curable compositions may be used to form at least a portion of a circuit board or a printed circuit board. In some embodiments, the substrate may be coated with a compatibilizer to improve the adhesion of the curable or cured composition to the substrate.

Composites and Coated Structures

In some embodiments, composites may be formed by curing the curable compositions disclosed herein. In other embodiments, composites may be formed by applying a curable composition to a substrate or a reinforcing material, such as by impregnating or coating the substrate or reinforcing material, and curing the curable composition.

The above described curable compositions may be in the form of a powder, slurry, or a liquid. After a curable composition has been produced, as described above, it may be disposed on, in, or between the above described substrates, before, during, or after cure of the curable composition.

For example, a composite may be formed by coating a substrate with a curable composition. Coating may be performed by various procedures, including spray coating, curtain flow coating, coating with a roll coater or a gravure coater, brush coating, and dipping or immersion coating.

In various embodiments, the substrate may be monolayer or multi-layer. For example, the substrate may be a composite of two alloys, a multi-layered polymeric article, and a metal-coated polymer, among others, for example. In other various embodiments, one or more layers of the curable composition may be disposed on or in a substrate. Other multi-layer composites, formed by various combinations of substrate layers and curable composition layers are also envisaged herein.

In some embodiments, the heating of the curable composition may be localized, such as to avoid overheating of a temperature-sensitive substrate, for example. In other embodiments, the heating may include heating the substrate and the curable composition.

Curing of the curable compositions disclosed herein may require a temperature of at least about 0° C., up to about 250° C., for periods of minutes up to hours, depending on the resin composition, hardener, and catalyst, if used. In other embodiments, curing may occur at a temperature of at least 20° C. and less than 50° C., for periods of minutes up to hours. In other embodiments, curing may occur at a temperature of at least 100° C., for periods of minutes up to hours. Post-treatments may be used as well, such post-treatments ordinarily being at temperatures between about 100° C. and 220° C.

In some embodiments, curing may be staged to prevent exotherms. Staging, for example, includes curing for a period of time at a temperature followed by curing for a period of time at a higher temperature. Staged curing may include two or more curing stages, and may commence at temperatures below about 180° C. in some embodiments, below about 150° C. in other embodiments, below about 120° C. in other embodiments, below about 100° C. in other embodiments, and below about 80° C. in yet other embodiments.

In some embodiments, curing temperatures may range from a lower limit of 0° C., 10° C., 20° C., 30° C., 40° C., 50° C., 60° C., 70° C., 80° C., 90° C., 100° C., 110° C., 120° C., 130° C., 140° C., 150° C., 160° C., 170° C., or 180° C. to an upper limit of 250° C., 240° C., 230° C., 220° C., 210° C., 200° C., 190° C., 180° C., 170° C., 160° C., 150° C., 140° C., 130° C., 120° C., 110° C., 100° C., 90° C., 80° C., 70° C., 60° C., 50° C. where the range may be from any lower limit to any upper limit. In other embodiments, curing temperature is ambient temperature.

The curable compositions and composites described herein may be useful as adhesives, structural and electrical laminates, coatings, castings, structures for the aerospace industry, and as circuit boards and the like for the electronics industry, among other applications. The curable compositions disclosed herein may also be used in electrical varnishes, encapsulants, semiconductors, general molding powders, filament wound pipe, storage tanks, blades for windmill turbines, structural and electrical composites, carbon or glass fiber reinforced plastic parts, liners for pumps, and corrosion resistant coatings, as well as for the formation of skis, ski poles, fishing rods, and other outdoor sports equipment, among others. In selected embodiments, the curable compositions described herein may be useful in the formation of resin coated foils, similar to those as described in U.S. Pat. No. 6,432,541, which is incorporated herein by reference.

Various processing techniques can be used to form composites containing the epoxy-based compositions disclosed herein. For example, filament winding, prepregging with or without solvent, resin transfer molding (RTM), vacuum assisted resin transfer molding (VARTM), sheet molding compounds (SMC), bulk molding compounds (BMC) and pultrusion are typical processing techniques in which the uncured epoxy resin may be used. Moreover, fibers in the form of bundles may be coated with the uncured epoxy resin composition, laid up as by filament winding, and cured to form a composite.

Embodiments disclosed herein may be particularly suitable for producing large epoxy-based parts produced by casting, potting, encapsulation, injection, and other molding techniques, by lamination, or by infusion. Such parts may include electrical potting, castings, moldings, or encapsulations, plastic tooling, and fiber-reinforced composites.

### EXAMPLES

Various terms, abbreviations and designations for the raw materials used in the following Examples are explained as follows:
(a) EEW stands for epoxy equivalent weight (on solids).
(b) AEW stands for amine equivalent weight (on solids).
(c) Epoxy Resin ER1 is a pre-catalyzed blend of diglycidyl ether of bisphenol A, diglycidyl ether of bisphenol F, and diglycidyl ether of dipropylene glycol. It does not contain volatile organic compound. The EEW is 180. The viscosity at 25° C. is about 1800 mPa·s.
(d) Amine Hardener AH1 is a blend of cycloaliphatic polyamine, aliphatic amidoamine, and reactive polyamide. It does not contain volatile organic compound. The AEW is 118. The viscosity at 25° C. is about 2800 mPa·s.
(e) Silica filler SF1 is a silica flour with no organic surface treatment (SiO₂>99%, moisture content<0.1%), available from Quarzwerke GmbH (Frenchen, Germany) under the tradename MILLISIL W12. The upper grain size d_{95%} is 50 μm and the specific surface BET (DIN 66132) is 0.9 m²/g.
(f) Polyethylene powder PE1 is a low density polyethylene powder. The Vicat softening point (ISO 306) is 80° C. and the melting point is 107° C. (onset=92° C.). The enthalpy of melting is 95 J/g. The upper grain size d_{95%} is less than 300 μm. The specific density is 0.92 g/cm³.
(g) Polyethylene powder PE2 is a low density polyethylene powder. The Vicat softening point (ISO 306) is 85° C. and the melting point is 103° C. (onset=56° C.). The enthalpy of melting is 63 J/g. The upper grain size d_{95%} is less than 300 μm. The specific density is 0.92 g/cm³.
(h) Polyethylene powder PE3 is a linear low density polyethylene powder. The crystallization point is 110° C. and the melting point is 123° C. (onset=76° C.). The enthalpy of melting is 116 J/g. The upper grain size d_{95%} is less than 100 μm. The specific density is 0.935 g/cm³.
(i) PVDF1 is a polyvinylidene fluoride powder. The melting point is 156° C. The upper grain size d_{95%} is less than 300 μm.
(j) SAT1 is a sodium acetate trihydrate powder. The melting point is 66° C. The enthalpy of melting is 274 J/g. The chemical formula is CH₃COONa.3H₂O.

Preparation of Clear Castings:

The individual resins (epoxy and hardener) are blended with optional fillers at ambient temperature, until homogenous. The epoxy and hardener resins, optionally containing filler, were then mixed together to prepare the formulations. Castings are prepared by pouring the formulations in open molds (200 mL glass bottles for the 100 g castings, 250 mL glass bottles for the 200 g castings, and 1 L glass bottles for the 500 g castings). The 1 L bottles are insulated in order to better represent adiabatic conditions. Castings are cured under a fume hood at 25° C. for 3 days before any measurement was done on the cured product.

Measurement of Gel Time and Peak Exotherm:

The formulations are prepared according to the general procedure described above. As soon as the epoxy and hardener resins are mixed, a stop-watch and an electronic thermometer are started to record time and formulation temperature, respectively. The gel time is determined as the time at which it was no longer possible to freely remove a wooden stick from the formulation. The reproducibility of the method is estimated to be about ±3 min for the gel time. The time at peak exotherm and the temperature at peak exotherm are recorded when the maximum temperature is reached. The reproducibility of the method is estimated to be about ±4 min for the time at peak exotherm and about ±3° C. for the temperature at peak exotherm.

Measurement of Viscosity:

The viscosity is determined with an ICI cone and plate rheometer. The formulations are prepared according to the general procedure described above. As soon as the epoxy and hardener resins are thoroughly mixed, a sample of formulation (about 0.5 g) is taken and placed on the temperature-controlled plate (±0.1° C.) kept at 25° C. Then the cone is lowered and contacted with the formulation. The rotation of the cone is started and the temperature is equilibrated at 25° C. The rotation speed of the cone is adjusted to obtain the best accuracy of measurement, as described in the apparatus operating procedure. The viscosity measurement is taken after less than 4 min. The reproducibility of the method is estimated to be about ±5%.

Measurement of the Glass Transition Temperature Tg

The glass transition temperature Tg is reported as the mid-point of the transition measured by differential scanning calorimetry (DSC). The heating ramp is 10° C./min. The reproducibility of the method is estimated to be about ±2° C.

Measurement the Enthalpy of Reaction

The enthalpy of reaction is measured by differential scanning calorimetry (DSC). The formulations are prepared according to the general procedure described above. As soon as the epoxy and hardener resins are thoroughly mixed, a small representative sample of formulation (about 10 mg) is taken and placed in a DSC aluminum pan after less than 2 min. The pan is loaded in the DSC measuring cell and the temperature was equilibrated to 40° C. within 2 min. Then the temperature is increased with a heating ramp of 5° C./min. The heat flow is recorded as a function of temperature. The enthalpy of reaction is determined by integrating the normalized heat flow between 40° C. and 180° C. The reproducibility of the method is estimated to be about ±2%.

### Measurement of Hardness

The hardness of the clear casting is measured with a Shore D durometer. The specimen is placed on a hard, horizontal surface. The durometer is held in a vertical position with the needle of the indenter at least 12 mm from any edge of the specimen. The durometer foot is applied to the specimen as rapidly as possible without shock, keeping the foot parallel to the surface of the specimen. Just sufficient pressure is applied to obtain firm contact between the foot and the specimen. The reported Shore D values are an average of at least 3 measurements. The reproducibility of the method is estimated to be about +3 units.

### Example 1 and Comparative Examples A and B

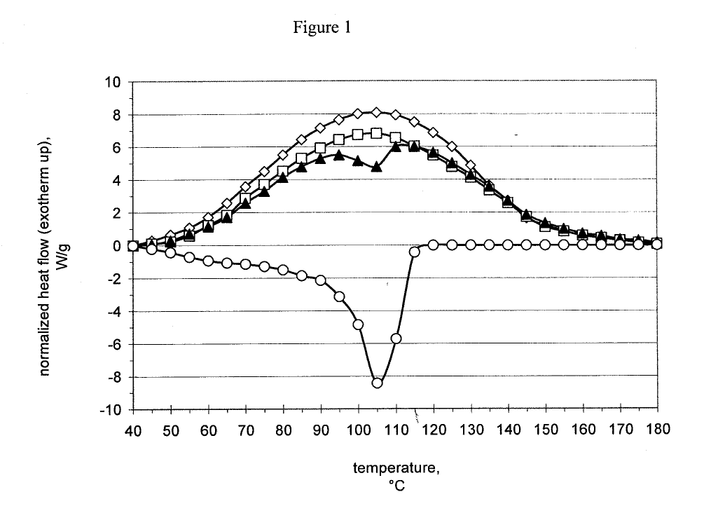

A formulation containing polyethylene powder PE1 (Example 1) and respective formulations containing either no filler (Comparative Example A) or silica filler SF1 (Comparative Example B) are prepared according to the general procedure. The composition of the formulations and the properties of the castings are shown in Tables 1 and 2. The normalized heat flow as a function of temperature is shown in FIG. 1.

TABLE 1
Composition of the formulations

| | Comparative | Comparative | |
|---|---|---|---|
| Component | Example A | Example B | Example 1 |
| Epoxy Resin ER1 | 61 g | 61 g | 61 g |
| Amine Hardener | 39 g | 39 g | 39 g |
| AH1 | | | |
| Silica Filler SF1 | 0 g | 23 g | 0 g |
| Polyethylene | 0 g | 0 g | 23 g |
| Powder PE1 | | | |

TABLE 2
Properties of the formulations

| | Comparative | Comparative | |
|---|---|---|---|
| | Example A | Example B | Example 1 |
| Properties before curing | | | |
| Viscosity of the | 2800 mPa · s | 4800 mPa · s | 3200 mPa ·s |
| formulation at 25° C. (5 min | | | |
| after mixing) | | | |
| Properties during curing | | | |
| Gel time at 25° C. (100 g) | 34 min | 45 min | 65 min |
| Gel time at 25° C. (500 g) | Not measured | 26 min | 34 min |
| Time at peak exotherm | Not measured | 36 min | 53 min |
| (500 g) | | | |
| Temperature at peak | not measured | 164 | 116 |
| exotherm (500 g), ° C. | | | |
| Enthalpy of reaction | 301 J/g | 249 J/g | 230 J/g |
| Properties after curing | | | |
| Tg, ° C. | 54 | 52 | 54 |
| Hardness Shore D | 70 | 69 | 70 |
| Color of the cured casting | not measured | core darker than | no significant |
| (500 g) | | the surface | difference between |
| | | (discoloration) | core and surface |

FIG. 1 is a graphical comparison of the normalized heat flow as a function of temperature for Example 1 (filled triangles), Comparative Example A (open diamonds), Comparative Example B (open squares), and polyethylene powder PE1 (open circles). The presence of 20% by weight of polyethylene powder PE1 slightly increases the viscosity of the formulation when compared to the unfilled formulation described in Comparative Example A. However the viscosity of the formulation described in Example 1 is significantly lower than the formulation containing 20% by weight of silica flour SF1 described in Comparative Example B.

The gel time and the time at peak exotherm are longer in the formulations containing fillers. The formulation described in Example 1 show slightly longer gel time and time at peak exotherm when compared with Comparative Example A.

The enthalpy of reaction measured by DSC is reduced by 17% by the introduction of silica flour SF1, whereas it is reduced by 24% by the introduction of polyethylene powder PE1. The peak exotherm temperature is reduced by 48° C. when comparing Example 1 and Comparative Example B.

After cross-sectioning of the cured casting, the color is observed both at the core (i.e., close to the geometric center of the casting) and near the surface. Comparative Example B shows a darker color at the core (discoloration), unlike Example 1 that shows no significant difference between the core and the surface.

Example 1 and Comparative Examples A and B show similar glass transition temperature and hardness. According to these results, the presence of polyethylene powder PE1 in the casting does not reduce the thermal resistance or the mechanical properties of the casting.

These results demonstrate the positive effect of an endothermic phase transition additive for lowering of the reaction exotherm when compared to a conventional filler that do not undergo an endothermic phase transition during the curing process.

### Examples 2 to 5 and Comparative Example C

A formulation containing a low density polyethylene powder PE2 (Example 2), a linear low density polyethylene powder PE3 (Example 3), a polyvinylidene fluoride powder (PVDF1), sodium acetate trihydrate (SAT1), and the respective formulation containing no filler (Comparative Example C) are prepared according to the general procedure. The composition of the formulations and the properties of the castings are shown in Tables 3 and 4.

TABLE 3
Composition of the formulations

| | Comparative | | | | | | | | | |
|---|---|---|---|---|---|---|---|---|---|---|
| Component | Example C | | Example 2 | | Example 3 | | Example 4 | | Example 5 | |
| Epoxy Resin ER1 | 100 | g | 100 | g | 100 | g | 100 | g | 100 | g |
| Amine Hardener | 64 | g | 64 | g | 64 | g | 64 | g | 64 | g |
| AH1 | | | | | | | | | | |
| Polyethylene | 0 | g | 40 | g | 0 | g | 0 | g | 0 | g |
| Powder PE2 | | | | | | | | | | |
| Polyethylene | 0 | g | 0 | g | 40 | g | 0 | g | 0 | g |
| Powder PE3 | | | | | | | | | | |
| Polyvinylidene | 0 | g | 0 | g | 0 | g | 40 | g | 0 | g |
| Fluoride Powder | | | | | | | | | | |
| PVDF1 | | | | | | | | | | |
| Sodium Acetate | 0 | g | 0 | g | 0 | g | 0 | g | 40 | g |
| Trihydrate SAT1 | | | | | | | | | | |

TABLE 4
Properties of the formulations

| Component | | | | | |
|---|---|---|---|---|---|
| Properties | Comparative | | | | |
| during curing | Example C | Example 2 | Example 3 | Example 4 | Example 5 |
| Time at peak | 22 | 29 | 32 | 25 | 33 |
| exotherm (200 g), | | | | | |
| min | | | | | |
| Temperature at | 190 | 125 | 95 | 132 | 117 |
| peak exotherm | | | | | |
| (200 g), ° C. | | | | | |

The time at peak exotherm are longer in the formulations containing fillers (Examples 2 to 5) when compared with Comparative Example C but remained acceptable. The peak exotherm temperature is drastically reduced by the addition of fillers that undergo an endothermic phase transition during the curing process in Examples 2 to 5 when compared with Comparative Example C. The temperature at peak exotherm is lower by 65° C. in Example 2, 95° C. in Example 3, 58° C. in Example 4, and 73° C. in Example 5, when compared with Comparative Example C.

These results demonstrate the positive effect of an endothermic phase transition additive for lowering of the reaction exotherm.

As described above, embodiments disclosed herein relate to epoxy-based compositions having a low reaction exotherm. More specifically, embodiments disclosed herein relate to epoxy-based compositions including an epoxy resin, a hardener, and an endothermic transition additive, wherein the epoxy-based composition has a lower reaction exotherm due to the presence of the endothermic phase transition additive.

Advantageously, embodiments disclosed herein may provide for epoxy-based compositions that experience a lower exotherm or a lower peak exotherm as compared to the same epoxy-based composition without an endothermic transition additive. The lower exotherm may result in one or more of more uniform properties throughout the matrix of a part formed, improved color, a decrease or elimination or epoxy polymer degradation, and less carbonization, as may result from a lower exotherm, especially for an interior portion of a large part where heat transfer is limited. The decrease in exotherm may also allow for one or more of larger part generation, increased cycle times, and other benefits.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

1. A curable epoxy-based composition having a lower peak exotherm during cure, the composition comprising:
at least one epoxy resin,
at least one hardener, and
at least one endothermic transition additive.

2. The epoxy-based compositions of claim 1, further comprising:
at least one catalyst.

3. The epoxy-based compositions of claim 1, further comprising:
at least one inorganic filler.

4. The epoxy-based compositions of claim 1, wherein the endothermic transition additive is a solid at ambient temperature and pressure.

5. The epoxy-based compositions of claim 1, wherein the endothermic transition additive has an enthalpy of an endothermic transition of at least 50 J/g.

6. The epoxy-based compositions of claim 1, wherein the endothermic transition additive has an enthalpy of an endothermic transition between 50 J/g and 600 J/g.

7. The epoxy-based compositions of claim 1, wherein the endothermic transition additive has an average particle size in the range between 5 nm and 500 microns.

8. The epoxy-based compositions of claim 1, wherein the endothermic transition additive is selected so as to undergo an endothermic transition at a temperature at least 5° C. less than a maximum exotherm the epoxy-based composition would experience during reaction of the at least one epoxy resin and the at least one hardener in the absence of the at least one endothermic transition additive.

9. The epoxy-based compositions of 1, wherein the endothermic transition additive is selected so as to undergo an endothermic transition at a temperature at least 10° C. less than a maximum exotherm the epoxy-based composition would experience during reaction of the at least one epoxy resin and the at least one hardener in the absence of the at least one endothermic transition additive.

10. The epoxy-based compositions of claim 1, wherein a temperature that the endothermic transition additive undergoes an endothermic transition is between 0° C. and 160° C.

11. The epoxy-based compositions of claim 1, wherein the epoxy-based composition comprises 50% or less, by weight, of the endothermic transition additive, based on a total weight of the epoxy resin, the hardener, and the endothermic transition additive.

12. A process for forming a curable epoxy-based composition having a lower peak exotherm, the process comprising:
admixing
at least one epoxy resin;
at least one hardener; and
at least one endothermic transition additive;
to form a curable composition.

13. The process of claim 12, the admixing further comprising mixing a catalyst.

14. The process of claim 12, the admixing further comprising mixing an inorganic filler.

15. The process of claim 12, wherein the endothermic transition additive is a solid at ambient temperature and pressure.

16. The process of claim 12, wherein the endothermic transition additive has an enthalpy of an endothermic transition of at least 50 J/g.

17. The process of claim 12, wherein the endothermic transition additive has an enthalpy of an endothermic transition between 50 J/g and 600 J/g.

18. The process of claim 12, wherein the endothermic transition additive has an average particle size in the range between 5 nm and 500 microns.

19. The process of claim 12, wherein the endothermic transition additive is selected so as to undergo an endothermic transition at a temperature at least 5° C. less than a maximum exotherm the epoxy-based composition would experience during reaction of the at least one epoxy resin and the at least one hardener in the absence of the at least one endothermic transition additive.

20. The process of claim 12, wherein the endothermic transition additive is selected so as to undergo an endothermic transition at a temperature at least 10° C. less than a maximum exotherm the epoxy-based composition would experience during reaction of the at least one epoxy resin and the at least one hardener in the absence of the at least one endothermic transition additive.

21. The process of claim 12, wherein a temperature that the endothermic transition additive undergoes an endothermic transition is between 0° C. and 160° C.

22. The process of claim 12, wherein the epoxy-based composition comprises 50% or less, by weight, of the endothermic transition additive, based on a total weight of the epoxy resin, the hardener, and the endothermic transition additive.

23. A process for forming a thermoset resin, the process comprising:
admixing
at least one epoxy resin;
at least one hardener; and
at least one endothermic transition additive;
to form a curable composition; and
thermally curing the curable composition at a temperature of at least 60° C. to form a thermoset resin.

24. The process of claim 23, the admixing further comprising mixing a catalyst.

25. The process of claim 23, the admixing further comprising mixing an inorganic filler.

26. The process of claim 23, further comprising disposing the curable composition in a mold.

27. The process of claim 23, wherein the endothermic transition additive is a solid at ambient temperature and pressure.

28. The process of claim 23, wherein the endothermic transition additive has an enthalpy of an endothermic transition of at least 50 J/g.

29. The process of claim 23, wherein the endothermic transition additive has an enthalpy of an endothermic transition between 50 J/g and 600 J/g.

30. The process of claim 23, wherein the endothermic transition additive has an average particle size in the range between 5 nm and 500 microns.

31. The process of claim 23, wherein the endothermic transition additive is selected so as to undergo an endothermic transition at a temperature at least 5° C. less than a maximum exotherm the epoxy-based composition would experience during reaction of the at least one epoxy resin and the at least one hardener in the absence of the at least one endothermic transition additive.

32. The process of claim 23, wherein a temperature that the endothermic transition additive undergoes an endothermic transition is between 0° C. and 160° C.

33. The process of claim 23, wherein the epoxy-based composition comprises 50% or less, by weight, of the endothermic transition additive, based on a total weight of the epoxy resin, the hardener, and the endothermic transition additive.

34. A thermoset resin, comprising the reaction product of:
at least one epoxy resin;
at least one hardener; and
at least one endothermic transition additive.

35. The thermoset resin of claim 34, the reaction product further comprising a catalyst.

36. The thermoset resin of claim 34, the reaction product further comprising an inorganic filler.

37. The thermoset resin of claim 34, wherein the endothermic transition additive is a solid at ambient temperature and pressure.

38. The thermoset resin of claim 34, wherein the endothermic transition additive has an enthalpy of an endothermic transition of at least 50 J/g.

39. The thermoset resin of claim 34, wherein the endothermic transition additive has an enthalpy of an endothermic transition between 50 J/g and 600 J/g.

40. The thermoset resin of claim 34, wherein the endothermic transition additive has an average particle size in the range between 5 nm and 500 microns.

41. The thermoset resin of claim 34, wherein the endothermic transition additive is selected so as to undergo an endothermic transition at a temperature at least 5° C. less than a maximum exotherm the epoxy-based composition would experience during reaction of the at least one epoxy resin and the at least one hardener in the absence of the at least one endothermic transition additive.

42. The thermoset resin of claim 34, wherein a temperature that the endothermic transition additive undergoes an endothermic transition is between 0° C. and 160° C.

43. The thermoset resin of claim 34, wherein the epoxy-based composition comprises 50% or less, by weight, of the endothermic transition additive, based on a total weight of the epoxy resin, the hardener, and the endothermic transition additive.

44. An epoxy-based part comprising the thermoset resin of claim 34, wherein the epoxy-based part comprises 200 grams or more of the thermoset resin.

45. The epoxy-based part of claim 44, wherein the epoxy-based part comprises 500 grams or more of the thermoset resin.

46. The epoxy-based part of claim 44, wherein the epoxy-based part comprises 1000 grams or more of the thermoset resin.

47. The epoxy-based part of claim 44, wherein the part is produced by at least one of casting, potting, encapsulation, injection, lamination, and infusion.

48. The epoxy based part of claim 44, wherein the part comprises at least one of an electrical potting, a casting, a molding, an encapsulation, a plastic tooling, and a fiber-reinforced composite.
